(19) United States
(12) Patent Application Publication
(10) Pub. No.: US 2025/0046097 A1
(43) Pub. Date: Feb. 6, 2025

(54) DEVICE, METHOD AND PROGRAM FOR EXTRACTING LINEAR OBJECTS

(71) Applicant: NIPPON TELEGRAPH AND TELEPHONE CORPORATION, Tokyo (JP)

(72) Inventors: Yukihiro GOTO, Musashino-shi, Tokyo (JP); Mitsuyasu YANAGIDA, Musashino-shi, Tokyo (JP); Yusuke SAKURAHARA, Musashino-shi, Tokyo (JP); Takashi EBINE, Musashino-shi, Tokyo (JP)

(73) Assignee: NIPPON TELEGRAPH AND TELEPHONE CORPORATION, Tokyo (JP)

(21) Appl. No.: 18/716,113

(22) PCT Filed: Dec. 9, 2021
(86) PCT No.: PCT/JP2021/045241

§ 371 Date: Jun. 3, 2024

(51) Int. Cl. G06V 20/58

(52) U.S. Cl. CPC G06V 20/58

(57) ABSTRACT

An object of the present disclosure is to enable extraction of a point cloud of a linear object such as a cable having a sparse point cloud.

The present disclosure is a device and a method in which point cloud data representing three-dimensional coordinates and a movement track at the time of measuring the point cloud data are acquired, and the number of point clouds within a certain distance D_{N} from the point cloud on the movement track is repeatedly counted to extract a point cloud of a linear object such as a cable 92.

### TECHNICAL FIELD

The present disclosure relates to a device, a method, and a program for creating a three-dimensional model.

### BACKGROUND ART

A technology for measuring point cloud data of an outdoor structure and three-dimensionally modeling the outdoor structure from the point cloud data by an in-vehicle three-dimensional laser scanner (mobile mapping system: MMS) has been developed (see, for example, Patent Literature 1 and 2).

In the technology of Patent Literature 1, after a point cloud acquired during one rotation of the laser scanner is set as a cluster called a scan line, it is detected that adjacent clusters are in a catenary shape, and thereby, a three-dimensional model of an overhead cable is created. However, in the present technology, there is a problem that it is difficult to create a scan line in a case where the point cloud data cannot be sufficiently acquired. Therefore, in the technology of Patent Literature 1, there is a problem that the point cloud of the cable portion cannot be extracted when the point cloud data cannot be sufficiently acquired due to a small number of point cloud outputs from the laser scanner or an influence of an obstacle or the like.

In the technology of Patent Literature 2, an overhead cable is detected from a point cloud by using traveling track information. However, in the present technology, only the ground level of the cable is obtained from the detected point cloud, and the point cloud of the cable portion cannot be extracted.

### CITATION LIST

### Patent Literature

Patent Literature 1: Japanese Patent No. 6531051
Patent Literature 2: WO2021/038647

### SUMMARY OF INVENTION

### Technical Problem

An object of the present disclosure is to enable extraction of a point cloud of a linear object such as a cable having a sparse point cloud.

### Solution to Problem

In a device and a method of the present disclosure,
point cloud data representing three-dimensional coordinates and a movement track at the time of measuring the point cloud data are acquired, and
the number of point clouds within a certain distance from a point cloud on the movement track is repeatedly counted to extract a point cloud of a linear object.

### Advantageous Effects of Invention

According to the present disclosure, it is possible to enable extraction of a point cloud of a linear object such as a cable having a sparse point cloud.

### BRIEF DESCRIPTION OF DRAWINGS

FIG. 1 illustrates an outline of a system according to the present embodiment.

FIG. 2 illustrates an example of point cloud data measured by an MMS.

FIG. 3 illustrates an outline of a method of extracting a linear object according to the present disclosure.

FIG. 4 illustrates a specific example of a first point cloud N.

FIG. 5 is an explanatory diagram of processing of creating a point cloud group of a cable possibility.

FIG. 6 is an explanatory diagram of processing of dividing a point cloud group of a cable possibility into point cloud groups of cable units.

FIG. 7 is an explanatory diagram of processing of obtaining an approximate line.

FIG. 8 illustrates a system configuration example of the present disclosure.

FIG. 9 illustrates an example of processing of a point cloud determination unit.

FIG. 10 illustrates an example of a cable model created from a point cloud N in FIG. 4.

FIG. 11 illustrates an example of processing of the point cloud determination unit.

FIG. 12 is an explanatory diagram of processing of calculating a road width from coordinates of a traveling track.

FIG. 13 is an explanatory diagram of processing of extending an approximate line to a road width.

FIG. 14 illustrates an example of a cable model created from a point cloud N.

### DESCRIPTION OF EMBODIMENTS

Hereinafter, embodiments of the present disclosure will be described in detail with reference to the drawings. The present disclosure is not limited to the embodiments to be described below. These embodiments are merely examples, and the present disclosure can be carried out in forms of various modifications and improvements based on knowledge of those skilled in the art. Components assigned the same reference numerals in the present specification and the drawings are the same components.

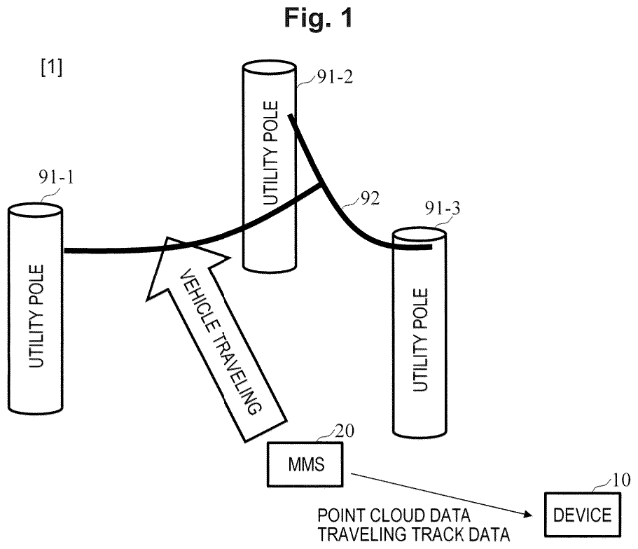

FIG. 1 illustrates an outline of a system according to the present embodiment. A system according to the present disclosure includes an MMS 20 and a device 10 according to the present disclosure. The device 10 acquires point cloud data measured by the MMS 20 mounted on a vehicle and the traveling track data that is coordinates of the vehicle traveling at the time of measuring the point cloud data, and stores them in association with each other. The point cloud data is data representing a shape of a structure as a set of points, and individual points represent three-dimensional coordinates.

The present disclosure shows an example in which a cable 92 is stretched between utility poles 91-1 and 91-2 and between utility poles 91-2 and 91-3. Then, the vehicle on which the MMS 20 is mounted travels under the cable 92 stretched between the utility poles 91-1 and 91-2. Although the present disclosure shows an example in which a vehicle travels, the moving means may be any moving means capable of traveling on a road such as a motorcycle, and the traveling track may be a movement track of any moving means. In the present embodiment, an example of extracting the point cloud of the cable 92 is illustrated, but the point cloud is not limited to the point cloud of the cable 92 that is an overhead cable stretched in the air, and may be any linear object. Hereinafter, when there is no need to distinguish the utility poles 91-1 to 91-3, they are referred to as utility poles 91.

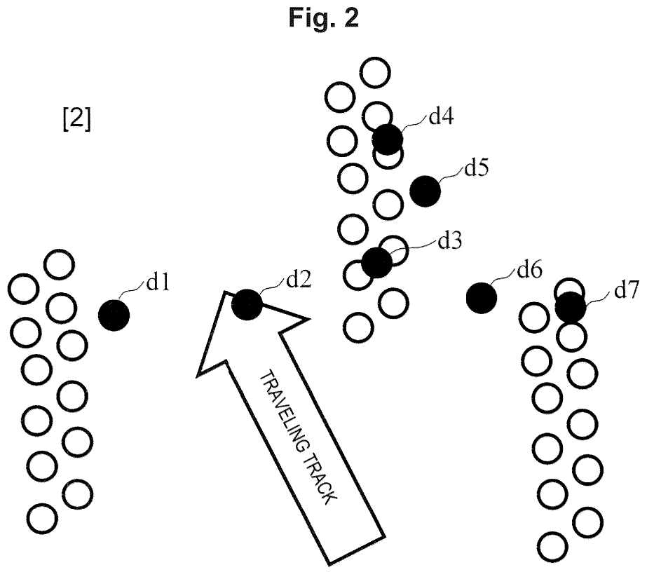

FIG. 2 illustrates an example of point cloud data measured by the MMS 20. Since there are a plurality of point clouds within a certain distance in the utility pole 91 as compared with the cable 92, it can be determined that it is the utility pole 91. As a result, the measured point cloud (white circle) of the utility pole 91 can be determined. Points d1 to d7 indicated by black circles are point clouds other than the utility pole 91.

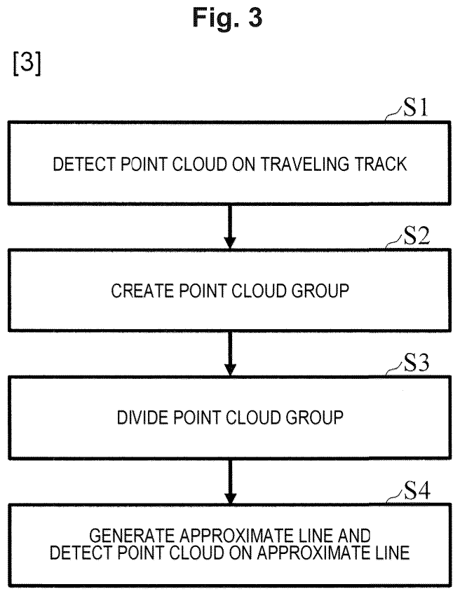

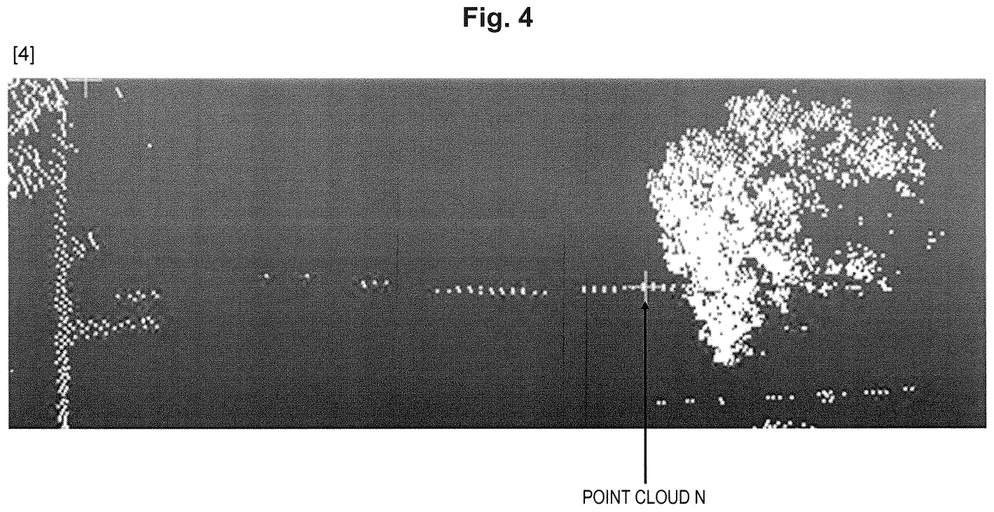

FIG. 3 illustrates an example of a method of extracting a linear object according to the present disclosure. The present disclosure uses a traveling track of a vehicle to detect whether a point cloud is present on the traveling track (S1). In the present embodiment, a point d2 exists on the traveling track. In this case, the point d2 is set as the first point cloud N. FIG. 4 illustrates a specific example of the first point cloud N.

Here, the point d2 is a point at which xy coordinates parallel to a ground surface among three-dimensional coordinates match xy coordinates of the traveling track of the vehicle on which the MMS 20 is mounted. The xy coordinates of the point d2 may completely match the xy coordinates of the traveling track, but may be within a predetermined range determined in advance from the xy coordinates of the traveling track.

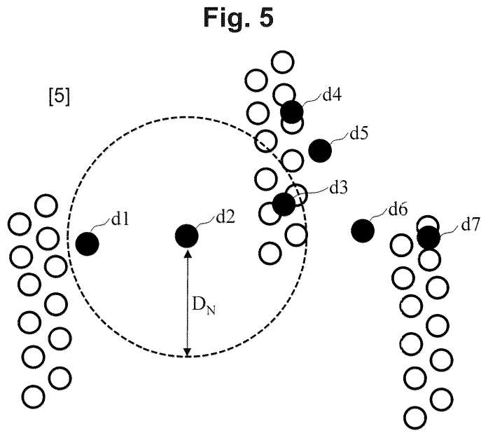

In the MMS 20, one connected line of the cable 92 is measured as a plurality of points. The interval between the plurality of points varies depending on the traveling speed of the vehicle and the distance from the vehicle. Therefore, as illustrated in FIG. 5, it is detected whether a point cloud exists within a certain distance D_{N} from the point d2 belonging to the first point cloud N, and the detected point cloud is set as a second point cloud M. Here, the certain distance D_{N} may be any distance that may occur when the cable 92 is measured by the MMS 20.

Since the cable 92 is thin, many point clouds are not measured in the cable 92. Therefore, when the second point cloud M is equal to or less than a predetermined number, it is determined that the first point cloud N is the point cloud of the cable possibility. When it is determined that the first point cloud N is the point cloud of the cable possibility, each of the second point clouds M is regarded as the first point cloud N. Then, by repeating the detection of the second point cloud M for each of the first point clouds N, a point cloud group of cable possibilities is created (S2). In the present embodiment, a point cloud group of cable possibilities of the points d1 to d6 illustrated in FIG. 2 is created.

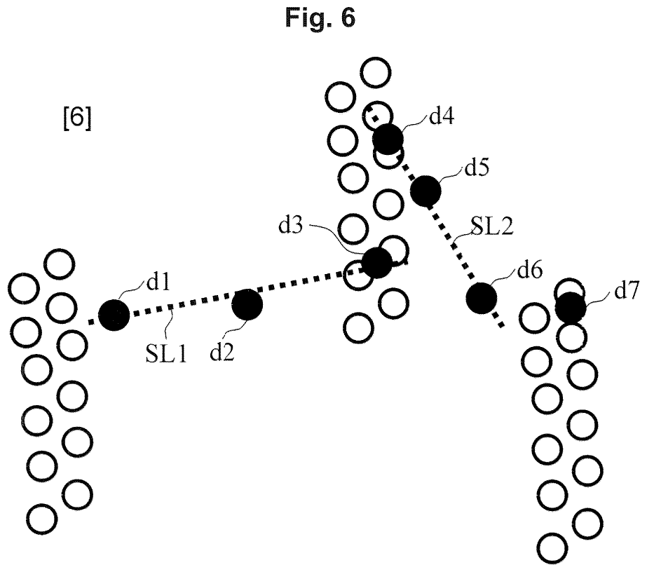

Next, the straight line detection is performed on the point cloud included in the point cloud group of the cable possibility, and the point cloud group is divided for each detected straight line to create the point cloud group in units of cables (S3). For example, as illustrated in FIG. 6, a straight line SL1 connecting points d1, d2, and d3 and a straight line SL2 connecting points d4, d5, and d6 are detected. Then, the point cloud group is divided into a point cloud group (d1, d2, d3) of the straight line SL1 and a point cloud group (d4, d5, d6) of the straight line SL2. Here, any algorithm such as Hough transform can be used for the straight line detection.

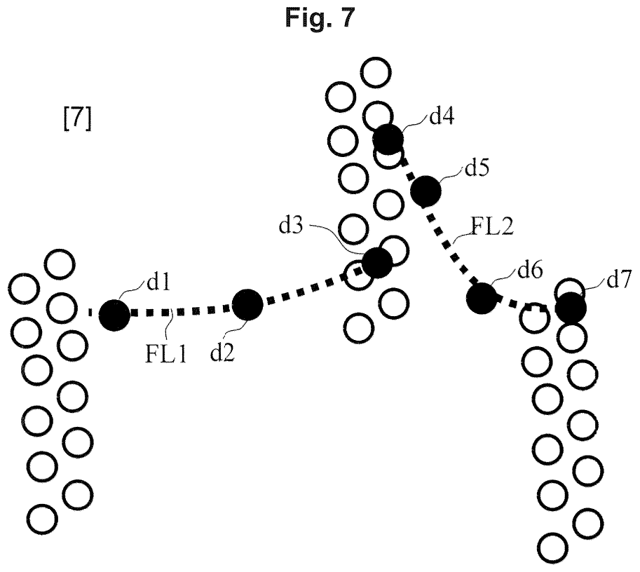

Next, the approximate line obtained by fitting is extended for each point cloud group of the cable unit, and a point cloud placed on the extended approximate line is included in the same point cloud group (S4). For example, as illustrated in FIG. 7, an approximate line FL1 obtained by fitting of the points d1, d2, and d3 is obtained, and an approximate line FL2 obtained by fitting of the points d4, d5, and d6 is obtained. Then, the point d7 arranged on the approximate line FL2 is added to the point cloud group of the points d4, d5, and d6. As a result, it is possible to extract a point cloud in which the distance between the points is extremely long and which is not detected in step S2. Therefore, the present disclosure can extract a point cloud of the cable 92.

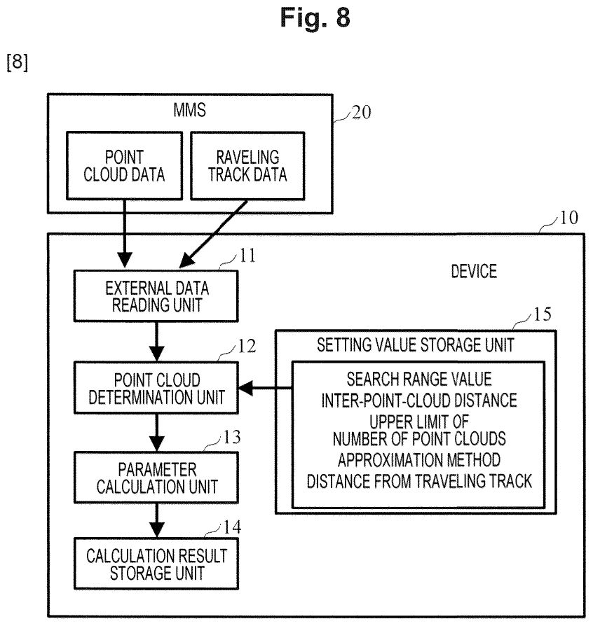

FIG. 8 illustrates a configuration example of a system of the present disclosure. The system according to the present disclosure includes the device 10 according to the present disclosure, and the MMS 20. The device 10 includes an external data reading unit 11, a setting value storage unit 15, a point cloud determination unit 12, a parameter calculation unit 13, and a calculation result storage unit 14. The device 10 can also be implemented by a computer and a program, and the program can be recorded in a recording medium or provided through a network.

The external data reading unit 11 has a function of reading the point cloud data and the traveling track data from the MMS 20.

The setting value storage unit 15 has a function of storing parameters used in the processing of the point cloud determination unit 12. The parameter is, for example, a search range value that defines a range of the point cloud data to be searched for the point d2 in step S2, a distance from the traveling track when the point d2 is detected in step S2, an inter-point-cloud distance that defines the “fixed distance D_{N}” used in step S2, an upper limit of the number of point clouds that defines the “predetermined number” used in step S2, and an approximation method used when obtaining an approximate line in step S4.

The point cloud determination unit 12 has functions of detecting a point cloud on the traveling track (S1), creating a point cloud group of cable possibilities (S2), dividing the cable unit into point cloud groups (S3), and generating an approximate line and detecting a point cloud on the approximate line (S4).

The parameter calculation unit 13 has a function of calculating a cable ground height, a slackness, and a span length.

The calculation result storage unit 14 has a function of storing values calculated by the point cloud determination unit 12 and the parameter calculation unit 13.

The external data reading unit 11, the setting value storage unit 15, the parameter calculation unit 13, and the calculation result storage unit 14 can be achieved by known ones.

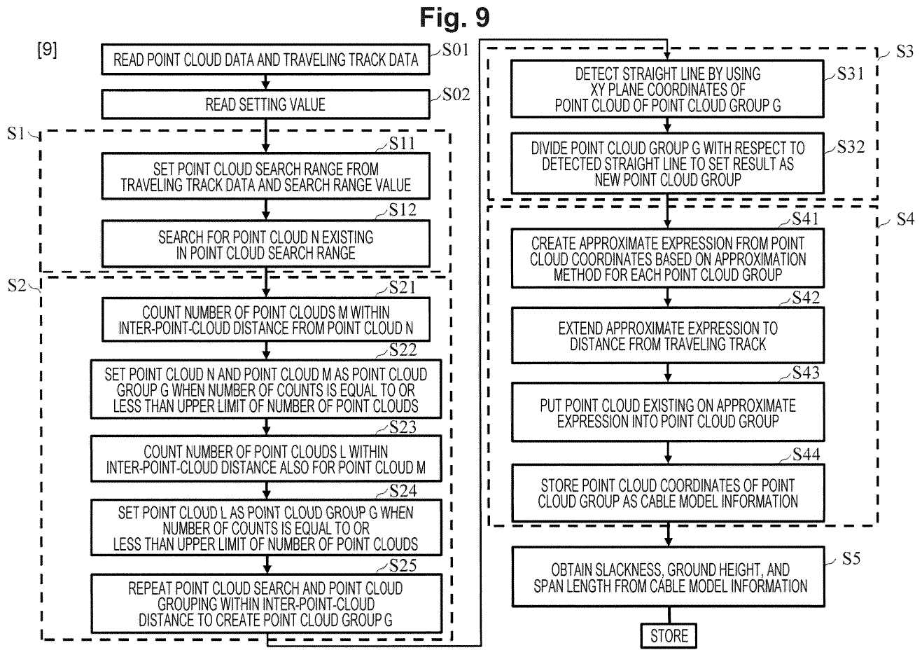

FIG. 9 illustrates an example of processing of the device 10.

The external data reading unit 11 reads the point cloud data and the traveling track data from the MMS 20 (S01), and the point cloud determination unit 12 reads the setting value from the setting value storage unit 15 (S02).

In step S1, the detection range is set on the traveling track on the basis of the traveling track information and the search range value (S11), and the point cloud N existing in the point cloud search range is searched (S12). As a result, a point cloud on the traveling track is detected.

In step S2, the point cloud determination unit 12 performs the following steps S21 to S25. A point cloud within a certain distance D_{N} from the detected point cloud is detected, and the number of the detected point clouds is counted (S21). When the number of counts is larger than the set value, the point cloud is not determined as the point cloud of the cable possibility. When the count number is equal to or less than the upper limit of the number of point clouds, the point cloud N and the point cloud M are set as a point cloud group G (S22). Also for the point cloud M, the number of point clouds L within the inter-point-cloud distance is counted (S23). When the count number is equal to or less than the upper limit of the number of point clouds, the point cloud L is set as a point cloud group G (S24). The detection and counting of the point cloud within the inter-point-cloud distance are repeated to create the point cloud group G (S25).

Depending on the wiring of the cable, the point cloud group may be a T-shaped point cloud group. In step S3, the point cloud determination unit 12 performs straight line detection (S31), and divides each straight line into point cloud groups in units of cables (S32).

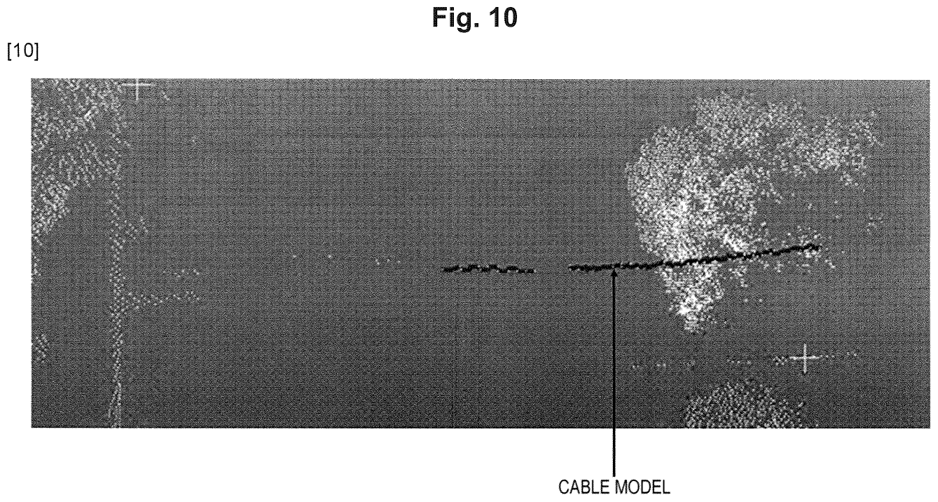

In step S4, the point cloud determination unit 12 approximates the point cloud group in units of cables with, for example, a primary straight line, a secondary curve, a catenary curve, or the like (S41), and extends the point cloud group (S42). The point cloud existing on the extension is also put into the point cloud group in units of cables (S43) to be used as the cable model (S44). FIG. 10 illustrates an example of a cable model created from the point cloud N in FIG. 4.

Finally, the parameter calculation unit 13 calculates the cable ground height, the slackness, the span length, and the like from the cable model (S5). The calculation result storage unit 14 stores the cable model created by the point cloud determination unit 12 and the calculation result of the parameter calculation unit 13.

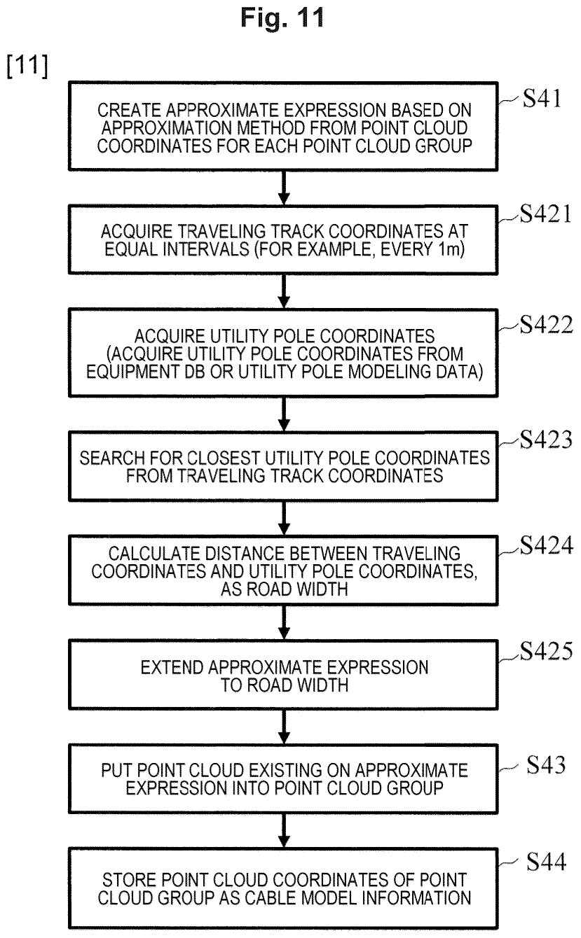

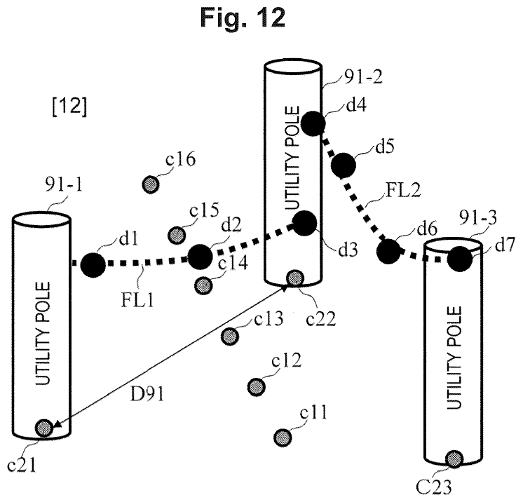

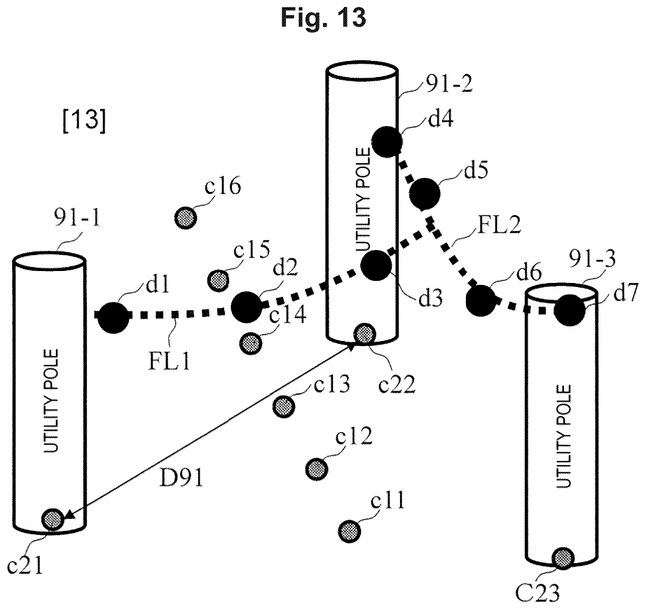

Since the utility pole 91 is not disposed on the road on which the vehicle travels, the cable 92 crosses the road. Therefore, the approximate line obtained in step S4 may be extended to the width of the road in order for the cable 92 to cross the road. FIG. 11 illustrates an example of processing of the point cloud determination unit 12 in this case. Since steps S1 to S3 and S5 are similar to those in FIG. 9, only step S4 will be described with reference to FIGS. 12 and 13.

An approximate expression is created from the point cloud coordinates for each point cloud group in units of cables on the basis of the approximation method (S41).

Coordinates c11 to c16 of the traveling track are acquired (S421). The intervals of the coordinates c11 to c16 are arbitrary, and may be equal intervals, for example, every 1 m.

Coordinates c21 to c23 of the utility pole 91 are acquired (S422). Here, the coordinates c21 to c23 of the utility pole 91 may be acquired from a facility DB that stores the geographical position of the utility pole 91, or may be acquired from coordinates of a utility pole model created using a measured point cloud (white circle illustrated in FIG. 2) of the utility pole 91.

The coordinates c11 and c16 of the utility poles 91-1 and 91-2 closest to the coordinates c21 to c22 of each traveling track acquired in step S421 are searched (S423).

A distance D91 between the coordinates c11 to c16 of the traveling track and the coordinates c21 and c22 of the utility poles 91-1 and 91-2 is calculated as a road width (S424).

As illustrated in FIG. 13, the approximate line FL1 is extended to the road width D91 (S425).

When the point cloud existing on the approximate line FL1 exists, the point cloud is put into the point cloud group of the points d1, d2, and d3 (S43). In the present embodiment, the approximate line FL2 exists on the extended approximate line FL1. In this case, the approximate line FL1 and the approximate line FL2 are connected.

The point cloud group coordinates of the point cloud group of in units of cables are stored as cable model information (S44). At this time, the approximate lines FL1 and FL2 are stored in the calculation result storage unit 14 as a cable model connected in a T shape.

As described above, in the present disclosure, the point cloud N of the cable 92 existing on the traveling track is detected using the traveling track data that is the coordinates of the vehicle on which the MMS 20 is mounted, the point cloud group of the cable possibility is determined on the basis of the distance D_{N} from the point cloud N and the number, and the point cloud of the cable portion is extracted on the basis of the point cloud included in the point cloud group of the cable possibility.

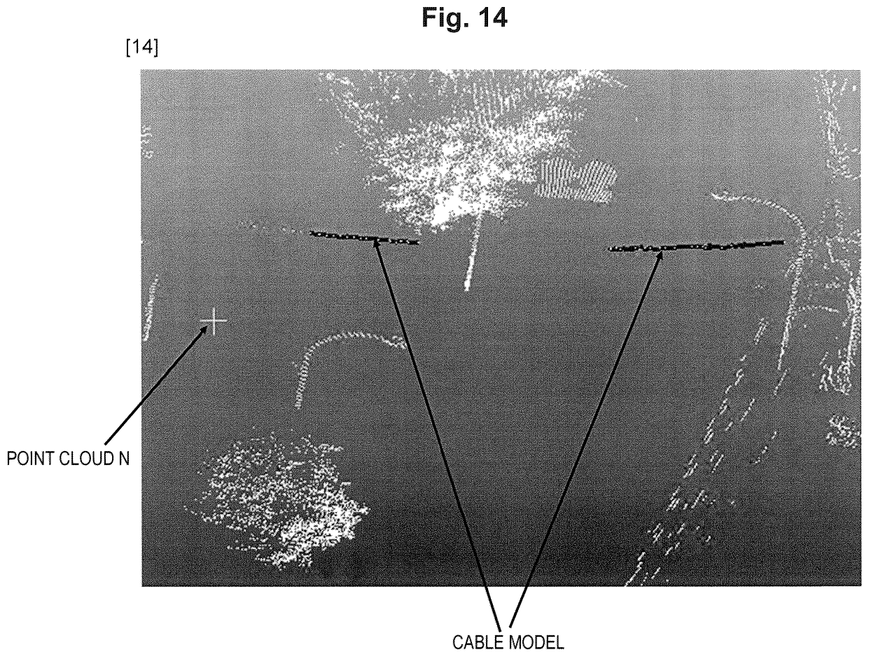

According to the present disclosure, a linear object is extracted with a point cloud existing on a traveling track as a starting point. Therefore, even when the number of point clouds is sparse, a point cloud group of a cable portion can be extracted, and a slackness or the like can be calculated from cable model information. In the specific example of the cable model of FIG. 10, an example in which the point cloud N is arranged on the straight line of the cable has been described; however, as illustrated in FIG. 14, if the point cloud exists within a certain distance D_{N} from the cable, the operation and effect of the present disclosure can be obtained.

### INDUSTRIAL APPLICABILITY

The present disclosure can be applied to the information and communications industry.

### REFERENCE SIGNS LIST

10 Device
11 External data reading unit
12 Point cloud determination unit
13 Parameter calculation unit
14 Calculation result storage unit
15 Setting value storage unit
20 MMS
91, 91-1, 91-2, 91-3 Utility pole
92 Cable

1. A device that
acquires point cloud data representing three-dimensional coordinates and a movement track at a time of measuring the point cloud data, and
repeatedly counts the number of point clouds within a certain distance from a point cloud on the movement track to extract a point cloud of a linear object.

2. The device according to claim 1 that
detects a straight line from the point cloud of the linear object that has been extracted, and
groups the point cloud of the linear object that has been extracted, for each of the straight line that has been detected.

3. The device according to claim 2 that
obtains an approximate line from the point cloud that has been grouped, and
includes a point cloud arranged on the approximate line in a same group.

4. The device according to claim 3,
wherein a primary straight line, a secondary curve, or a catenary curve is used as the approximate line.

5. The device according to claim 3,
wherein the linear object is an overhead cable that crosses a road, and
the approximate line is extended in order for the overhead cable to cross the road.

6. The device according to claim 5 that
calculates a road width by using a distance from the movement track to a nearest utility pole, and
extends the approximate line to the road width.

7. A method comprising:
acquiring point cloud data representing three-dimensional coordinates and a movement track at a time of measuring the point cloud data; and
repeatedly counting the number of point clouds within a certain distance from a point cloud on the movement track to extract a point cloud of a linear object.

8. A non-transitory computer-readable medium having computer-executable instructions that, upon execution of the instructions by a processor of a computer, cause the computer to function as the device according to claim 1.
